(19) United States
(12) Patent Application Publication
(10) Pub. No.: US 2023/0174837 A1
(43) Pub. Date: Jun. 8, 2023

(54) THERMALLY CONDUCTIVE RESIN COMPOSITION AND MOLDED ARTICLE COMPRISING SAME

(71) Applicant: TOYOBO CO., LTD., Osaka (JP)

(72) Inventors: Motonobu KAMIYA, Otsu-shi, Shiga (JP); Takahiro SHIMIZU, Otsu-shi, Shiga (JP)

(73) Assignee: TOYOBO CO., LTD., Osaka (JP)

(21) Appl. No.: 17/913,620

(22) PCT Filed: Mar. 26, 2021
(86) PCT No.: PCT/JP2021/013037

§ 371 Date: Sep. 22, 2022

(30) Foreign Application Priority Data
Mar. 30, 2020 (JP) 2020-060688

(51) Int. Cl. C09K 5/14; C08K 7/00; C08G 63/183

(52) U.S. Cl. CPC C09K 5/14; C08K 7/00; C08G 63/183; C08K 2201/001; C08K 2201/005

(57) ABSTRACT

The present invention relates to a thermally conductive resin composition excellent in toughness and thermal conductivity. The thermally conductive resin composition comprises a thermoplastic resin (A) and scale-like graphite (B), and is free from a polyester elastomer, wherein a content of the thermoplastic resin (A) is 45 to 60 parts by mass and a content of the scale-like graphite (B) is 40 to 55 parts by mass (based on 100 parts by mass in total of the thermoplastic resin (A) and the scale-like graphite (B)), the scale-like graphite (B) comprises scale-like graphite (B1) having a mean particle diameter D50 of 150 to 400 μm and scale-like graphite (B2) having a mean particle diameter D50 of 10 to 40 μm, a mass ratio B1:B2 is 94:6 to 60:40, and thermal conductivity in a plane direction of a molded article obtained from the thermally conductive resin composition is 8 W/(m·K) or more.

### TECHNICAL FIELD

The present invention relates to a thermally conductive resin composition excellent in toughness and thermal conductivity.

### BACKGROUND ART

With miniaturization and high integration of electrical/electronic equipment, heat generation of incorporated components and increasing temperatures of usage environments become remarkable, and thus improved heat dissipation of constituting members is highly demanded. Particularly, for the heat dissipation of automotive members and high-power LEDs, the constituting members composed of a metal and/or a ceramic having high thermal conductivity are used at present. However, to reduce weight, and to enhance processability and a degree of freedom of the shape, resin materials having high thermal conductivity and toughness are required.

As a method for giving the thermal conductivity to a resin, disclosed is a method for adding a highly thermally conductive filler such as graphite.

In Patent Literature 1, a resin composition excellent in the thermal conductivity obtained by adding graphite particles having specific properties, particle diameter, and aspect ratio to the resin is disclosed, but addition of a large amount of the graphite likely reduces the toughness, resulting in insufficient strength of a molded article.

Further, as a technology to improve the thermal conductivity, investigated is to add the graphite and a nano-sized carbon filler in the resin. In Patent Literature 2, for example, disclosed is a method for extruding a resin composition in which flaky graphite and nano-sized carbon nano-fibers are dispersed in a thermoplastic elastomer, to a corded strand using a twin-screw extruding kneader, followed by pressing this by rolls, thereby continuously obtaining a sheet having high thermal conductivity. According to this method, the graphite is oriented by pressing with rolls, and highly efficient heat conduction paths are formed by nano-fibers dispersed between layers, thereby obtaining processed products continuously, while achieving high thermal conductivity. However, because of a premise of pressing with the rolls, there has been occurred a problem that the degree of freedom of the shape of the processed products obtained is extremely limited.

While on the contrary, in Patent Literature 3, disclosed is a thermally conductive resin composition having high thermal conductivity obtained by using scale-like graphite and carbon nano-fibers or carbon nano-tubes, preventing nano-materials from fracture due to shear during melt-kneading by adding a fluorine resin, and dispersing and maintaining the nano-materials between layers of oriented surfaces of the graphite even in the melt-kneading and injection-molding. However, very costly carbon nano-fibers and the like have to be used, thereby having been difficult to use in versatile.

In Patent Literature 4, on the other hand, by adding the scale-like graphite, expanded graphite, and a polyester elastomer to a polyester resin, flexibility is given to improve the toughness. However, since residence stability of the polyester elastomer is poor under a special molding condition that causes residence, newly found have been a problem that the toughness of the molded article is reduced under the above molding conditions, and a problem that a pressure is difficult to rise during molding, deteriorating appearance.

### CITATION LIST

### Patent Literature

PTL 1: WO 2015/190324

PTL 2: Japanese Patent Laying-Open No. 2015-36383

PTL 3: Japanese Patent Laying-Open No. 2016-204570

PTL 4: WO 2018/181146

### SUMMARY OF INVENTION

### Technical Problem

The present invention is made to solve the above problems, and an objective of the present invention is to provide a thermally conductive resin composition free from a polyester elastomer and excellent in toughness and thermal conductivity.

### Solution to Problem

The present inventors have intensively studied to solve the above problems. As a result, by mixing scale-like graphite having a specific large-diameter and scale-like graphite having a specific small-diameter in a specific ratio in a thermoplastic resin such as a thermoplastic polyester resin, the small-diameter graphite exists between two pieces of the large-diameter graphite to form good thermal conduction paths and to improve thermal conductivity, and to decrease an amount of the graphite needed to attain target thermal conductivity, thereby finding to be able to solve the problem of toughness decrease owing to the amount of the graphite, and arrived at completion of the present invention. More specifically, the present invention provides the followings.

[1] A thermally conductive resin composition comprising a thermoplastic resin (A) and scale-like graphite (B) and being free from a polyester elastomer, wherein a content of the thermoplastic resin (A) is 45 to 60 parts by mass and a content of the scale-like graphite (B) is 40 to 55 parts by mass (based on 100 parts by mass in total of the thermoplastic resin (A) and the scale-like graphite (B)), the scale-like graphite (B) comprises scale-like graphite (B1) having a mean particle diameter D50 of 150 to 400 μm and scale-like graphite (B2) having a mean particle diameter D50 of 10 to 40 μm, a mass ratio B1:B2 is 94:6 to 60:40, and thermal conductivity in a plane direction of a molded article obtained from the thermally conductive resin composition is 8 W/(m·K) or more.

[2] The thermally conductive resin composition according to [1], wherein the thermoplastic resin (A) is a polyester resin.

[3] The thermally conductive resin composition according to [1], wherein the thermoplastic resin (A) is polyethylene terephthalate and/or polybutylene terephthalate.

[4] A molded article formed of the thermally conductive resin composition according to any one of [1] to [3].

### Advantageous Effects of Invention

According to the present invention, a resin composition excellent in toughness and thermal conductivity can be obtained by mixing (B1) and (B2) of the scale-like graphite, in a specific amount each having specific properties and ratio, in a thermoplastic resin (A). Further, this resin composition is excellent in heat-shock resistance due to exhibition of good toughness and also excellent in flowability thereof by keeping an amount of the graphite in the resin composition low.

### DESCRIPTION OF EMBODIMENTS

Hereinafter, embodiments of the present invention will be described in detail, but the present invention is not limited to the following embodiments at all, and can be carried out with appropriate modifications within a scope of the objective of the present invention. In addition, although there is a case that description may be omitted as appropriate where the description overlaps, this does not limit the gist of the invention.

Hereinafter, a thermoplastic resin (A), scale-like graphite (B), other components, and a method for producing a thermally conductive resin composition will be described in turn. The scale-like graphite (B) comprises scale-like graphite (B1) having a mean particle diameter D50 of 150 to 400 μm and scale-like graphite (B2) having a mean particle diameter D50 of 10 to 40 μm. Hereinafter, the former may be referred to as the “scale-like graphite (B1)” and the latter as the “scale-like graphite (B2).”

[Thermoplastic Resin (A)]

In a thermally conductive resin molded body of the present invention, the thermoplastic resin (A) used as a base component (a matrix component) is not particularly limited, but examples typically include a polyarylene resin, a polyamide resin, a polyolefin resin, a polyester resin. Particularly, considering heat shock resistance, desirable is the polyester resin with high dimensional stability.

Among these, examples of the polyarylene resin specifically include polyphenylene sulfide (PPS), polyether ketone (PEK), polyether ether ketone (PEEK), poly(2,6-dimethyl-1,4-phenylene)ether (PPE) which is a polyarylene oxide. In the polyarylene oxide, a stylene resin such as polystylene, impact-resistant polystylene can be added. Above all, from the viewpoint of heat resistance, chemical resistance and a cost, the PPS is more preferable.

Further, the polyamide resin is a resin obtained from an amino acid, a lactam, and any of a diamine and a dicarboxylic acid, as main raw materials. Specifically, examples include polyamide 6, polyamide 66, polyamide 46, polyamide 11, polyamide 12, polyamide 610, polyamide 69, polyamide 6T, polyamide 9T, polyamide MXD6, a polyamide 6/66 copolymer, a polyamide 6/610 copolymer, a polyamide 6/6T copolymer, a polyamide 6/66/610 copolymer, a polyamide 6/12 copolymer, a polyamide 6T/12 copolymer, a polyamide 6T/66 copolymer, a polyamide 6/6I copolymer, a polyamide 66/6I/6 copolymer, a polyamide 6T/6I copolymer, a polyamide 6T/6I/66 copolymer, a polyamide 6/66/610/12 copolymer, a polyamide 6T/M-5T copolymer. Above all, from the viewpoint of well-balanced chemical resistance, impact-resistance and flowability of the resin molded body obtained, the polyamide 6, the polyamide 66, the polyamide 12, and a copolymer containing one of these as a main component are preferable, and the polyamide 6 and a copolymer containing the polyamide 6 as a main component are more preferable.

Furthermore, examples of the polyolefin resin specifically include a homopolymer or a copolymer containing a recurring unit generated from α-olefins such as ethylene and propylene as a main component, e.g., a homopolymer of the propylene, a homopolymer of the ethylene, and a block or random copolymer in which the ethylene and other α-olefins (e.g., propylene and buten-1) are copolymerized. One or more of these can be used to the extent that they contribute to properties of the resin material. The polyolefin resin used in the present invention may be any one of a straight chain or a branched chain. In case of using the polypropylene resin as the above polyolefin resin, any of polypropylene resin such as isotactic, atactic, and syndiotactic can be also used. In case of using the polyethylene resin as the above polyolefin resin, examples of the polyethylene include a linear low-density polyethylene (LLDPE), a low-density polyethylene (LDPE), a high-density polyethylene (HDPE), an ultralow-density polyethylene (ULDPE), an ultrahigh-molecular weight polyethylene (UHMW-PE).

Examples of the polyester resin specifically include polyethylene terephthalate, polypropylene terephthalate, polybutylene terephthalate, polycyclohexanedimethylene terephthalate, polyhexylene terephthalate, polyethylene naphthalate, polypropylene naphthalate, polybutylene naphthalate, polyethylene isophthalate/terephthalate, polypropylene isophthalate/terephthalate, polybutylene isophthalate/terephthalate, polyethylene terephthalate/naphthalate, polypropylene terephthalate/naphthalate, polybutylene terephthalate/naphthalate, polybutylene terephthalate/decanedicarboxylate, polyethylene terephthalate/cyclohexanedimethylene terephthalate, polyethylene terephthalate/succinate, polypropylene terephthalate/succinate, polybutylene terephthalate/succinate, polyethylene terephthalate/adipate, polypropylene terephthalate/adipate, polybutylene terephthalate/adipate, polyethylene terephthalate/sebacate, polypropylene terephthalate/sebacate, polybutylene terephthalate/sebacate, polyethylene terephthalate/isophthalate/adipate, polypropylene terephthalate/isophthalate/adipate, polybutylene terephthalate/isophthalate/succinate, polybutylene terephthalate/isophthalate/adipate, polybutylene terephthalate/isophthalate/sebacate, bisphenol A/terephthalic acid, bisphenol A/isophthalic acid, bisphenol A/terephthalic acid/isophthalic acid. Above all, from the viewpoint of the heat resistance and the heat-shock resistance, preferable are the polyethylene terephthalate (PET) and polybuthylene terephthalate (PBT), and particularly preferable is the polyethylene terephthalate (PET).

Intrinsic viscosity (IV) of the polyethylene terephthalate is not particularly limited, but preferably 0.4 to 1.2 dl/g, and more preferably 0.5 to 1.1 dl/g. The intrinsic viscosity (IV) of the polybutylene terephthalate is not particularly limited, but preferably 0.6 to 1.0 dl/g, and more preferably 0.7 to 0.9 dl/g. The intrinsic viscosity (IV) (unit: dl/g) is measured by solving 0.1 g of the resin in 25 ml of a mixed solvent of phenol/tetrachloroethane (mass ratio: 6/4) and using a Ubbellohde viscosity tube, at 30° C. The intrinsic viscosity within the above range provides good toughness.

It is a preferable aspect that the thermally conductive resin composition of the present invention is free from a polyester elastomer that reduces the toughness of a molded article obtained in molding of a hot runner and the like, in which heat degradation is extremely accelerated, and moreover that causes appearance to worse. Further, it is a preferable aspect that the thermally conductive resin composition of the present invention uses only a polyester resin free from a polyester elastomer as the thermoplastic resin (A), and does not contain other resin components.

A content of the thermoplastic resin (A) is 45 to 60 parts by mass, preferably 47 to 58 parts by mass, and more preferably 48 to 57 parts by mass, based on 100 parts by mass in total of the thermoplastic resin (A) and the scale-like graphite (B) in the thermally conductive resin composition. In the thermally conductive resin composition of the present invention, each amount to be added (an addition ratio) of raw material components is a content (a content ratio) as it is, in the thermally conductive resin composition.

[Scale-Like Graphite (B)]

In the present invention, the scale-like graphite (B) preferably mixed in the thermally conductive resin composition is not particularly limited, and a variety of graphite can be used, and any of natural graphite and artificially produced scale-like graphite may be used. These of the scale-like graphite may be any of being dried, fired, pulverized and/or classified. Pulverizing treatment is not particularly limited, and can be performed by using e.g., a conventionally known apparatus such as a rod mill, a ball mill, and a jet mill. Expandable graphite can obtain high thermal conductivity compared with other graphite, but is brittle and reduction of the toughness is prone to occur. Further, the expandable graphite has a low bulk density and is prone to cause poor penetration during production. Therefore, from the viewpoint of handling, preferable is the scale-like graphite.

Above all, the present inventors have intensively studied about a type, a mean particle diameter, and an addition ratio of the scale-like graphite, and found out a combination that can obtain the maximum thermal conductivity at less amount to be added, to arrive at the present invention. When a ratio of the scale-like graphite (B1) and the scale-like graphite (B2) is within a specific range, and each mean particle diameter is within a specific range, obtained can be the thermally conductive resin composition having well-balanced various properties such as the thermal conductivity, the toughness, and the heat-shock resistance.

The scale-like graphite (B1) has a mean particle diameter D50 of 150 to 400 μm. The mean particle diameter D50 of the scale-like graphite (B1) is preferably 180 to 370 μm, and more preferably 250 to 350 μm. When the mean particle diameter D50 is less than 150 μm, the thermal conductivity of the resin composition is reduced or the amount to be added has to be increased. The larger the particle diameter is, the more the thermal conductivity tends to be improved, but when it exceeds 400 μm, strength and the flowability of the resin composition is reduced and dispersion in the resin becomes worse, and thus it can be a factor which reduces the thermal conductivity on the contrary. The mean particle diameter D50 is determined by measuring volume distribution by a laser scattering particle size measuring instrument and setting a particle diameter at 50% in the measured volume distribution as the mean particle diameter D50.

The scale-like graphite (B2) has a mean particle diameter D50 of 10 to 40 μm. The mean particle diameter D50 of the scale-like graphite (B2) is preferably 15 to 35 μm, and more preferably 18 to 32 μm. By setting the mean particle diameter D50 of the scale-like graphite (B2) in the above range, and combining it with the scale-like graphite (B1), attained can be high thermal conductivity that is the target. The measurement method of the mean particle diameter D50 is as described above.

By using together the scale-like graphite (B1) and the scale-like graphite (B2) as the scale-like graphite (B), the maximum thermal conductivity can be obtained. A mass ratio (B1:B2) of the scale-like graphite (B1) and the scale-like graphite (B2) is 94:6 to 60:40, preferably 94:6 to 70:30, and more preferably 92:8 to 75:25. When a content of the scale-like graphite (B2) is more than 40% by mass of the total, the thermal conductivity and the heat-shock property of the resin composition are drastically reduced to be unpreferable.

A content of the scale-like graphite (B) of the present invention is 40 to 55 parts by mass, preferably 42 to 53 parts by mass, and more preferably 43 to 52 parts by mass, based on 100 parts by mass in total of the thermoplastic resin (A) and the scale-like graphite (B) in the thermally conductive resin composition. Even if two kinds of the scale-like graphite having the specific mean particle diameter D50 described above are used at the specific ratio, when the amount to be added itself of the scale-like graphite (B) is small, the thermal conductivity is reduced, and when more than 55 parts by mass on the contrary, the handling significantly becomes worse during the production, thereby greatly reducing the flowability, the toughness, etc. of the resin composition to be unpreferable.

The thermally conductive resin composition of the present invention can contain at least one selected from the group consisting of a thermally conductive filler except for the scale-like graphite (B) and a bulking agent except for the thermally conductive filler to the extent that the effects are not compromised, with the thermoplastic resin (A) and the scale-like graphite (B). Shapes of the thermally conductive filler except for the scale-like graphite (B) and the bulking agent are not limited, but examples include a variety of shapes such as scale-like, fibrous, flaky, platelet, spherical, particulate, fine particulate, nano-particulate, aggregated particulate shape, tube shape, nano-tube shape, wire shape, rod shape, indeterminate form, rugby ball shape, hexahedral shape, composite particulate shape in which large particles and fine particles are composed, and liquid. Examples of the thermally conductive filler except for the scale-like graphite (B) specifically include a metal filler such as aluminum and nickel, a low-melting point alloy having a liquidus temperature of 300° C. or more and a solidus temperature of 150° C. or more and 250° C. or less, a metal oxide such as aluminum oxide, magnesium oxide, silicon oxide, beryllium oxide, copper oxide, and cuprous oxide, a metal nitride such as aluminum nitride and silicon nitride, a metal carbide such as silicon carbide, a metal carboxylate such as magnesium carbonate, an insulating carbon material such as diamond, a metal hydroxide such as aluminum hydroxide and magnesium hydroxide, alumina, boron nitride, glass fibers, carbon fibers, potassium titanate whiskers, silicon nitride fibers, carbon nano-tubes, talc, and wollastonite, and one or more of these can be used. An amount to be added is not particularly limited, but as the amount to be added is increased, the thermal conductivity can be improved. The thermally conductive filler except for the above scale-like graphite (B) may be a natural substance, or a synthesized one. In case of the natural substance, a production place is not particularly limited, and can be appropriately selected.

For the resin composition of the present invention, a known bulking agent in addition to the above thermally conductive filler can be widely used depending on the purpose. Examples of the bulking agent other than the thermally conductive filler include, e.g., diatomaceous earth powder, basic magnesium silicate, fired clay, fine powder silica, quarts powder, crystalline silica, kaolin, antimony trioxide, fine powder mica, molybdenum disulfide, inorganic fibers such as rock wool, ceramic fibers, and asbestos, and a glass-made bulking agent such as a glass fiber, glass powder, glass cloth, and fused silica. By using these bulking agents, it becomes possible to improve preferable properties in applying the resin composition such as the thermal conductivity, mechanical strength, or wear resistance. Furthermore, organic bulking agents of paper, pulp, wood, synthetic fibers such as polyamide fibers, aramid fibers, and boron fibers, resin powder such as polyolefin powder can be mixed in combination as required.

The thermally conductive filler and the bulking agent except for the thermally conductive filler used in the present invention may be subjected to surface treatment by using various surface treatment agents such as a silane treating agent, a stearic acid, and an acrylic monomer, to enhance adhesivity of an interface between the resin and the filler or to facilitate workability. The surface treatment agents are not particularly limited, but used can be conventionally known one of, e.g., a silane coupling agent, a titanate coupling agent. Above all, an epoxy-group containing silane coupling agent such as epoxy silane, an amino-group containing silane coupling agent such as amino silane, and polyoxyethylene silane, etc. are preferable because they are less likely to degrade physical properties of the resin. A surface treatment method of the filler is not particularly limited, but a general treatment method can be used.

The scale-like graphite (B) in the present invention preferably occupies 80% by mass or more, when a total of the scale-like graphite (B), the thermally conductive filler except for the scale-like graphite (B), and the bulking agent except for the thermally conductive filler is 100% by mass, more preferably occupies 90% by mass or more, even more preferably occupies 95% by mass or more, and may occupy 100% by mass.

### [Other Components]

The thermally conductive resin composition of the present invention, depending on the purpose, may further contain a variety of additives such as an antioxidant, a heat-resistance stabilizer, an ultraviolet absorbing agent, an antistatic agent, a dye, a pigment, a lubricating agent, a plasticizer, a mold-releasing agent, a crystallization accelerator, a crystalline nucleating agent, and an epoxy compound.

In the thermally conductive resin composition of the present invention, the total of the thermoplastic resin (A) and the scale-like graphite (B) preferably occupies 80% by mass or more, more preferably occupies 90% by mass or more, and even more preferably occupies 95% by mass or more.

The thermally conductive resin composition of the present invention is produced by melt-kneading of the thermoplastic resin (A), the scale-like graphite (B), and other components. In general, the graphite tends to be pulverized at the melt-kneading and molding processing, and thus the larger the volume mean particle diameter of the graphite before the melt-kneading is, the larger the volume mean particle diameter of the scale-like graphite after the melt-kneading and the molding processing is retained, thereby improving the thermal conductivity and molding processability. During the melt-kneading, it is in general that the scale-like graphite (B) is added from a hopper with the resin, and mixed, but to suppress pulverizing as long as possible and to keep good thermal conductivity as described above, the scale-like graphite (B1) is preferably added by side feeding at a second half step of the melt-kneading, in particular.

The “thermal conductivity in a plane direction” referred to in the present invention means the thermal conductivity with respect to a direction to which a melt resin flows when producing the molded body. The thermal conductivity in the plane direction of the thermally conductive resin composition of the present invention is 8 W/(m·K) or more, and preferably 8.2 W/(m·K) or more. The upper limit value is not particularly limited, and higher the limit is, the better is, but it is considered that in view of materials used, preferable is 11 W/(m·K) or less, more preferable is 10 W/(m·K) or less.

The thermally conductive resin composition of the present invention is excellent in the toughness. The molded article obtained by injection-molding the thermally conductive resin composition of the present invention based on a method described in Examples satisfies both of 60 MPa or more of bending strength and 0.7% or more of a bending deflection ratio. In view of satisfying these physical properties, it is judged that the molded article is excellent in the toughness.

### EXAMPLES

Hereinafter, the present invention will be further described in detail with examples, but is not limited by these examples.

### Examples 1 to 7, and Comparative Examples 1 to 10

In Examples 1 to 7 and Comparative Examples 1 to 10, as components of a thermally conductive resin composition, the following materials were used.

[A; Thermoplastic Resin]

A-1: Polyethylene terephthalate (produced by TOYOBO Co., Ltd. IV=0.63 dl/g)
A-2: Polyethylene terephthalate (produced by TOYOBO Co., Ltd. IV=1.10 dl/g)
A-3: Polybutylene terephthalate (produced by TOYOBO Co., Ltd. IV=0.83 dl/g)

[B; Scale-Like Graphite]

B1-1: Scale-like graphite, produced by Nippon Graphite Industries, Co., Ltd. (mean particle diameter D50: 200 μm)
B1-2: Scale-like graphite, produced by Nippon Graphite Industries, Co., Ltd. (mean particle diameter D50: 300 μm)
B1-3: Scale-like graphite, produced by Nippon Graphite Industries, Co., Ltd. (mean particle diameter D50: 600 μm)
B2-1: Scale-like graphite, produced by Nippon Graphite Industries, Co., Ltd. (mean particle diameter D50: 20 μm)
B2-2: Scale-like graphite, produced by Chuetsu Graphite Works, Co., Ltd. BF-30AK (mean particle diameter D50: 30 μm)

As to the scale-like graphite, used were all having 96% of fixed carbon concentration. In addition, as to the mean particle diameter D50 described above, after a graphite sample was charged in an aqueous solution of 20% by mass of sodium hexametaphosphate in a beaker of 100 ml, the graphite sample was dispersed using an ultrasonic dispersion machine for 30 minutes, and then charged in a chamber of a laser scattering type particle size measuring device (MICROTRAC HRA (available from Nikkiso, Co., Ltd.) 9320-X100), to measure a volume distribution at a measuring time of 120 seconds, and the measured particle diameter at 50% in the volume distribution was defined as the mean particle diameter D50.

[Polyester Elastomer]

C-1: Polyester elastomer (produced by TOYOBO, Co., Ltd. PELUPRENE P-70B)

[Other Additives]

Antioxidant: IRGANOX1010, produced by BAFS SE
Mold-releasing agent: LICOWAX-OP, produced by Clariant AG
Crystallization accelerator: KRM4004, produced by Sanyo Chemical Industries, Ltd.

Components shown in Tables 1 and 2 were dry-blended at a ratio of contents (parts by mass) shown in Tables 1 and 2, and melt-kneaded by using a biaxial extruder (produced by The Japan Steel Works, LTD. TEX-30) under the conditions of 270° C. of a cylinder temperature, 10 kg/hr of an amount to be discharged, and 150 rpm of a screw speed, to produce pellets of the thermally conductive resin composition. Using the pellets obtained, test pieces were prepared, to measure the thermal conductivity (plane direction) and toughness, and to confirm appearances, of the thermally conductive resin composition. Measurement results of the thermally conductive resin composition of Examples 1 to 7 are shown in Table 1.

Furthermore, the measurement results of the thermal conductivity (plain direction) and the toughness, and confirmation results of the appearances of the thermally conductive resin composition of Comparative Examples 1 to 10 are shown in Table 2 in the same way. Here, each physical property of the thermally conductive resin composition was measured in accordance with the following method.

<Thermal Conductivity>

After molding a flat plate having a shape of 100 mm×100 mm×1 mm (thickness) by injection-molding using an injection molding machine produced by Toshiba Machine Co., Ltd. Under the conditions of 280° C. of a cylinder temperature and 140° C. of a metal mold temperature, a center portion of the flat plate was cut into a 25 mm×25 mm square, to measure a thermal diffusivity coefficient and specific heat capacity in the plane direction (flow direction of the resin) by the laser flush method using a TC-7000H produced by ULVAC RIKO, Inc. By using those numbers and specific gravity separately measured by using the same molded article, the thermal conductivity was obtained by calculation.

<Toughness (Bending Strength, Bending Deflection Ratio)>

Bending strength and a bending deflection ratio were measured in accordance with ISO-178. Test pieces were prepared by injection-molding under the conditions of 280° C. of the cylinder temperature and 140° C. % of the metal mold temperature. When both of 60 MPa or more of the bending strength and 0.7% or more of the bending deflection ratio were satisfied, it was judged that the toughness was excellent.

<Appearance>

Using the injection molding machine produced by Toshiba Machine Co., Ltd., under the conditions of 280° C. of the cylinder temperature and 140° C. of the metal mold temperature, the pellets were retained for 10 minutes, and then a flat plate having a shape of 100 mm×100 mm×1 mm (thickness) was molded by injection-molding, and the appearance was observed visually.

A: Glossy surface, no poor appearance at all, good
B: No glossy surface on the whole molded body, poor appearance occurring

TABLE 1

| | | Examples | | | | | | |
|---|---|---|---|---|---|---|---|---|
| | | 1 | 2 | 3 | 4 | 5 | 6 | 7 |
| Composition/ | (A-1) Polyethylene Terephthalate | 15 | 55 | 55 | 55 | 55 | 50 | |
| parts by mass | IV = 0.63 | | | | | | | |
| | (A-2) Polyethylene Terephthalate | 40 | | | | | | |
| | IV = 1.10 | | | | | | | |
| | (A-3) Polybutylene Terephthalate | | | | | | | 55 |
| | IV = 0.83 | | | | | | | |
| | (B1-1) Scale-Like Graphite 200 μm | 40 | 40 | 35 | 35 | | | |
| | (B1-2) Scale-Like Graphite 300 μm | | | | | 40 | 43 | 40 |
| | (B2-1) Scale-Like Graphite 20 μm | 5 | 5 | 10 | | 5 | 7 | 5 |
| | (B2-2) Scale-Like Graphite 30 μm | | | | 10 | | | |
| | B1/B2 ratio | 89/11 | 89/11 | 78/22 | 78/22 | 89/11 | 86/14 | 89/11 |
| Evaluation | Thermal Conductivity (plane | 8.3 | 8.3 | 8.9 | 8.7 | 8.4 | 10.1 | 8.6 |
| | direction) (W/(m · K)) | | | | | | | |
| | Bending Strength (MPa) | 78 | 62 | 63 | 65 | 61 | 60 | 71 |
| | Bending Deflection Ratio (%) | 0.8 | 0.7 | 0.7 | 0.7 | 0.7 | 0.8 | 0.8 |
| | Appearance | A | A | A | A | A | A | A |

*Additives: IRGANOX1010 0.2 parts by mass, LICOWAX-OP 0.5 parts by mass, and KRM4004 0.2 parts by mass, are common to all.

TABLE 2

| | | Comparative Examples | | | | | | | | | |
|---|---|---|---|---|---|---|---|---|---|---|---|
| | | 1 | 2 | 3 | 4 | 5 | 6 | 7 | 8 | 9 | 10 |
| Composition/ | (A-1) Polyethylene Terephthalate | 60 | 50 | 60 | 55 | 55 | 55 | 55 | 45 | 45 | 45 |
| parts by mass | IV = 0.63 | | | | | | | | | | |
| | (A-2) Polyethylene Terephthalate | | | | | | | | | | |
| | IV = 1.10 | | | | | | | | | | |
| | (B1-1) Scale-Like Graphite 200 μm | | 50 | | | | | | 55 | 50 | |
| | (B1-2) Scale-Like Graphite 300 μm | 40 | | 20 | 45 | 43 | 25 | | | | |
| | (B1-3) Scale-Like Graphite 600 μm | | | | | | | | | | 50 |
| | (B2-1) Scale-Like Graphite 20 μm | | | 20 | | 2 | 20 | 45 | | | |
| | (B2-2) Scale-Like Graphite 30 μm | | | | | | | | | | |
| | (C-1) Polyester Elastomer | | | | | | | | | 5 | 5 |
| | B1/B2 ratio | 100/0 | 100/0 | 50/50 | 100/0 | 96/4 | 56/44 | 0/100 | 100/0 | 100/0 | 100/0 |
| Evaluation | Thermal Conductivity (plane | 6.7 | 9.1 | 6.2 | 7.7 | 7.9 | 7.8 | 6.3 | 12.8 | 9.1 | 10.1 |
| | direction) (W/(m · K)) | | | | | | | | | | |
| | Bending Strength (MPa) | 71 | 54 | 79 | 65 | 70 | 77 | 69 | 50 | 55 | 49 |
| | Bending Deflection Ratio (%) | 1.1 | 0.7 | 1.1 | 0.7 | 0.7 | 0.8 | 0.7 | 0.6 | 0.8 | 0.6 |
| | Appearance | A | A | A | A | A | A | A | A | B | B |

*Additives: IRGANOX1010 0.2 parts by mass, LICOWAX-OP 0.5 parts by mass, and KRM4004 0.2 parts by mass, are common to all.

As clear from Tables 1 and 2, while the thermally conductive resin compositions of Examples 1 to 7 of the present invention were well-balanced in the thermal conductivity and the toughness by mixing the graphite having the specific particle diameter in the thermoplastic resin in a ratio so as to satisfy a specific range, while any one of the thermal conductivity, the toughness, and the appearance was unfortunately low in Comparative Examples 1 to 10.

### INDUSTRIAL APPLICABILITY

According to the present invention, the resin composition excellent in the toughness and the thermal conductivity can be obtained and thus suitably used for application in which heat generation becomes a problem, and further used as an alternative of a metal, etc. leading to weight reduction, enhancement of a degree of freedom of the shape, and to easily producing a molded body, thereby significantly contributing to an industrial world.

1. A thermally conductive resin composition comprising a thermoplastic resin (A) and scale-like graphite (B) and being free from a polyester elastomer, wherein a content of the thermoplastic resin (A) is 45 to 60 parts by mass and a content of the scale-like graphite (B) is 40 to 55 parts by mass (based on 100 parts by mass in total of the thermoplastic resin (A) and the scale-like graphite (B)), the scale-like graphite (B) comprises scale-like graphite (B1) having a mean particle diameter D50 of 150 to 400 μm and scale-like graphite (B2) having a mean particle diameter D50 of 10 to 40 μm, a mass ratio B1:B2 is 94:6 to 60:40, and thermal conductivity in a plane direction of a molded article obtained from the thermally conductive resin composition is 8 W/(m·K) or more.

2. The thermally conductive resin composition according to claim 1, wherein the thermoplastic resin (A) is a polyester resin.

3. The thermally conductive resin composition according to claim 1, wherein the thermoplastic resin (A) is polyethylene terephthalate and/or polybutylene terephthalate.

4. A molded article formed of the thermally conductive resin composition according to claim 1.
